(19) United States
(12) Patent Application Publication
(10) Pub. No.: US 2025/0345960 A1
(43) Pub. Date: Nov. 13, 2025

(54) CUTTING APPARATUS, IMAGE FORMING SYSTEM, AND CUTTING POSITION DETERMINING METHOD

(71) Applicant: Konica Minolta, Inc., Tokyo (JP)

(72) Inventor: Takehiro Ogushi, Tokyo (JP)

(73) Assignee: Konica Minolta, Inc., Tokyo (JP)

(21) Appl. No.: 19/201,231

(22) Filed: May 7, 2025

(30) Foreign Application Priority Data
May 10, 2024 (JP) 2024-076978

(51) Int. Cl. B26D 5/06; B26D 5/00; B32B 38/00; B32B 41/00; B65H 35/04

(52) U.S. Cl. CPC B26D 5/06; B26D 5/00; B32B 38/0004; B32B 41/00; B65H 35/04; B65H 2511/10

(57) ABSTRACT

A cutting apparatus includes: a cutter that cuts a recording medium, both sides of which are laminated with a laminate film, at a position to an outer side by a predetermined margin amount; a recording medium outer shape detector that detects an outer shape portion of the recording medium; and a hardware processor that determines a cutting position by the cutter based on a position of the outer shape portion detected by the recording medium outer shape detector.

### CROSS-REFERENCE TO RELATED APPLICATION

Japanese patent application No. 2024-076978, filed on May 10, 2024, including the description, claims, drawings, and abstract, is incorporated herein by reference in its entirety.

### BACKGROUND OF THE INVENTION

### Technical Field

The present invention relates to a cutting apparatus, an image forming system, and a cutting position determining method.

### Description of Related Art

Conventionally, a laminating apparatus has been used which coats a sheet such as a print product with a transparent resin (laminating) film. In the laminating apparatus, a long laminate film having an adhesive layer and continuously supplied in a longitudinal direction and sheets sequentially conveyed from an upstream side are overlapped and conveyed. Then, the laminating apparatus continuously laminates the laminate film and the sheet which are conveyed.

In such a laminating apparatus, if the sheet is fed out with even a slight change in posture, the sheet is covered with the laminate film while remaining in the distorted posture. For example, Japanese Patent No. 7158640 discloses a laminator having a feeding step of feeding a plurality of flat sheets held by a guide member one by one to a conveying table while holding the posture of a front end portion of an uppermost sheet by suction pads arranged as planes in a plurality of rows of two or more.

The technique described in the above-described Japanese Patent No. 7158640 is intended to improve the accuracy of cutting processing to be performed later by aligning the posture of the sheet before lamination. However, even if the posture of the sheet is corrected before the lamination processing, in a case in which the laminate film meanders during conveyance or the like, the position of the sheet in the width direction with respect to the laminate film after the lamination is displaced. If cutting is performed by the cutting apparatus in this state, a waste (defective) product in which sheets are unevenly distributed in the width direction is generated. This is because the cutting apparatus normally performs cutting at a cutting position corresponding to the film width, which is an outer shape of a cutting target.

### SUMMARY OF THE INVENTION

The present invention has been made to solve the above-described problem, and an object of the present invention is to eliminate a shift in a posture of a recording medium in a laminate film with respect to an outer shape of a cut laminate film.

A cutting apparatus according to an aspect of the present invention comprises: a cutter that cuts a recording medium, both sides of which are laminated with a laminate film, at a position to an outer side by a predetermined margin amount;
a recording medium outer shape detector that detects an outer shape portion of the recording medium; and
a hardware processor that determines a cutting position by the cutter based on a position of the outer shape portion detected by the recording medium outer shape detector.

An image forming system according to another aspect of the present invention includes:
an image forming apparatus that forms an image on a recording medium;
a laminating apparatus that laminates, with a laminate film, both sides of the recording medium on which the image is formed; and
the cutting apparatus that includes:
a cutter that cuts the recording medium at a position to an outer side by a predetermined margin amount;
a recording medium outer shape detector that detects an outer shape portion of the recording medium; and
a hardware processor that determines a cutting position by the cutter based on a position of the outer shape portion detected by the recording medium outer shape detector.

A cutting position determining method according to another aspect of the present invention is performed by a cutting apparatus that comprises a cutter, a recording medium outer shape detector, and a hardware processor, the method comprising:
cutting, by the cutter, a recording medium, both sides of which are laminated with a laminate film, at a position to an outer side by a predetermined margin amount;
detecting, by the recording medium outer shape detector, an outer shape portion of the recording medium; and
determining, by the hardware processor, a cutting position by the cutter based on a position of the outer shape portion detected by the recording medium outer shape detector.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating an example of correspondence between a sheet position and a cutting position in a conventional case in which there is no sheet position shift;

FIG. 2 is a diagram illustrating an example of the correspondence between the sheet position and the cutting position in a conventional case in which the sheet position is shifted;

FIG. 3 is a diagram illustrating an example of correspondence between the sheet position and the cutting position in a conventional case in which the shift of the sheet is corrected;

FIG. 4 is a diagram illustrating an example of correspondence between the sheet position and the cutting position in a case in which a size of a conventional sheet includes an error;

FIG. 5 is a diagram illustrating an example of correspondence between the sheet position and the cutting position in a case in which a conventional laminate film meanders to a left side in a conveyance direction;

FIG. 6 is a diagram illustrating an example of correspondence between the sheet position and the cutting position in a case in which cutting is performed along the initial cutting position illustrated in FIG. 5;

FIG. 7 is a schematic diagram illustrating an overall configuration of an image forming system according to an embodiment of the present invention;

FIG. 8 is a block diagram which shows an example of the configuration of a control system for an image forming apparatus, a laminating apparatus, a cutting apparatus, and a sheet ejection device which constitute the image forming system according to the embodiment of the present invention;

FIG. 9 is a diagram illustrating an example of a cutting position determining parameter in a sheet direction according to the embodiment of the present invention;

FIG. 10 is a diagram illustrating an example of the cutting position determining parameter in a sheet conveyance direction according to the embodiment of the present invention;

FIG. 11 is a flowchart illustrating an example of a procedure of cutting position determining processing according to the embodiment of the present invention; and

FIG. 12 is a flowchart illustrating an example of a procedure of sheet outer shape detecting processing according to the embodiment of the present invention.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described in detail with reference to the drawings. In the present specification and drawings, elements having substantially the same function or configuration are denoted by the same reference numerals, and redundant descriptions of the constituent elements are omitted.

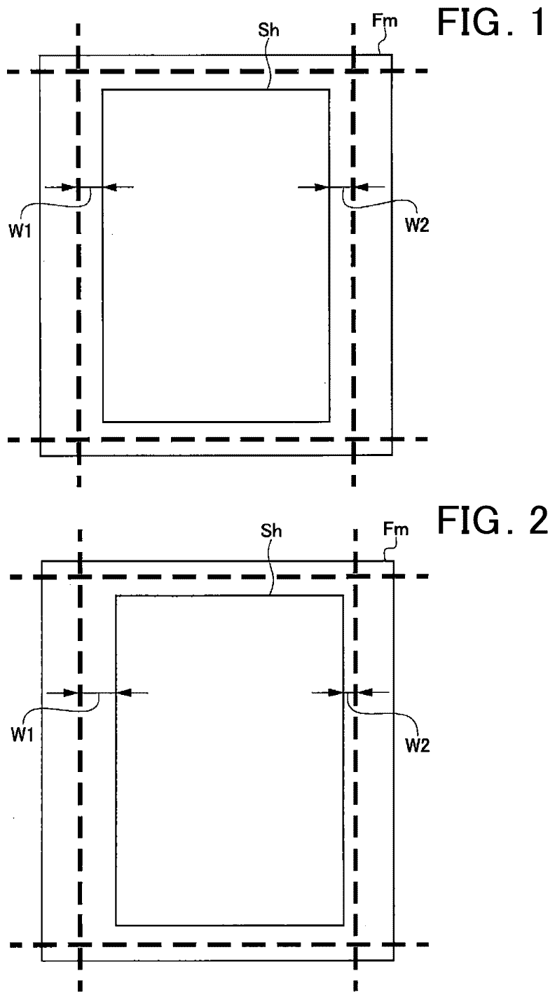

Prior to description of embodiments of the present invention, conventional problems to be solved by the present invention will be described with reference to FIG. 1 to FIG. 4.

FIG. 1 is a diagram illustrating an example of correspondence between a sheet position and a cutting position in a case in which there is no sheet position shift, and FIG. 2 is a diagram illustrating an example of the correspondence between the sheet position and the cutting position in a case in which the sheet position is shifted. In FIG. 1 and FIG. 2, the cutting position is indicated by a broken solid line. In a case in which the sheet Sh is appropriately conveyed to a target position, as shown in FIG. 1, a gap W1 between the cutting position and a sheet edge side on a left side of the drawing and a gap W2 between the cutting position and the sheet edge side on a right side of the drawing are equal to each other.

On the other hand, when the sheet Sh meanders during conveyance, as shown in FIG. 2, the gap W1 on the left side of the drawing and the gap W2 on the right side of the drawing become uneven. In the example illustrated in FIG. 2, the gap W2 on the right side is narrower than the gap W1 on the left side. If cutting is performed in a case in which the posture of the sheet Sh is in such a state, a product after cutting becomes waste (failure).

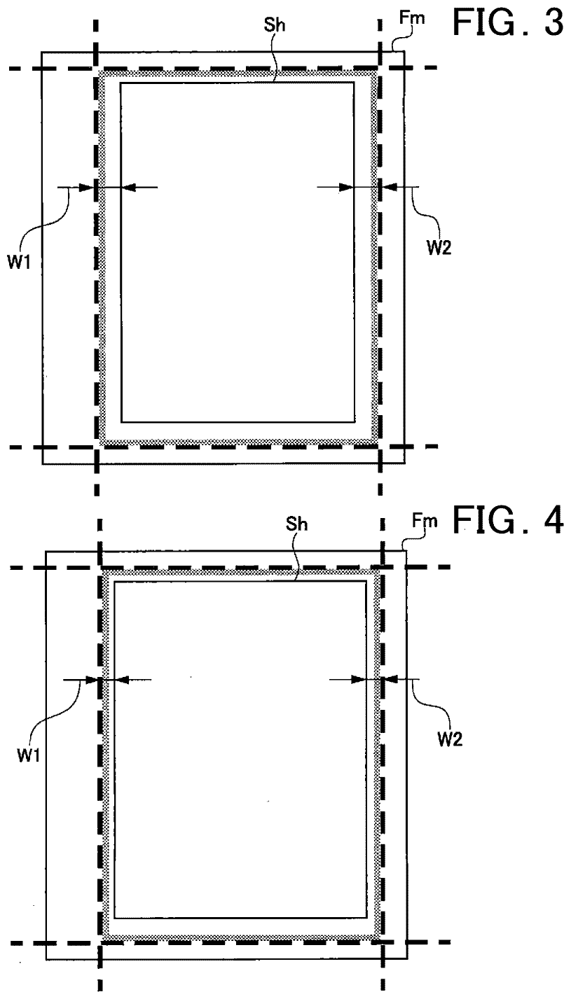

FIG. 3 is a diagram illustrating an example of correspondence between the sheet position and the cutting position in a case in which a shift of the sheet Sh is corrected. In the example illustrated in FIG. 3, a position of the sheet Sh is adjusted such that the gap W1 on the left side and the gap W2 on the right side in the drawing are equal to each other. Such an adjustment is performed, and thus it is possible to prevent the shift from occurring between an outer shape of the product after cutting, which is indicated by a dot pattern frame, and the posture of the sheet Sh.

FIG. 4 is a diagram illustrating an example of correspondence between the sheet position and the cutting position in a case in which a size of the sheet Sh includes an error. Usually, the outer shape of the sheet Sh includes an error of about 2 mm, and FIG. 4 illustrates an example in which the outer shape of the sheet Sh is larger than a specified size. Also in the example illustrated in FIG. 4, the position of the sheet Sh is adjusted such that the gap W1 on the left side and the gap W2 on the right side in the drawing are equal to each other. Note that even in a case in which the outer shape of the sheet Sh is larger than the specified size, the cutting position is set to a position similar to that in a case in which the sheet Sh has the specified size. Thus, although the size of the gap W1 and the size of the gap W2 become smaller than those illustrated in FIG. 1 to FIG. 3, the outer shape of the product is kept constant.

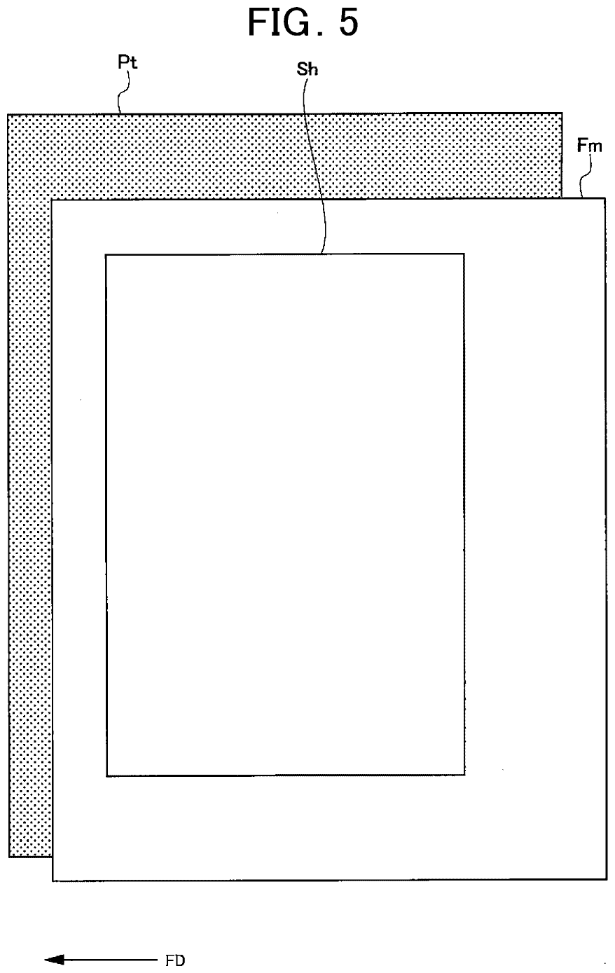

FIG. 5 is a diagram illustrating a correspondence example between the sheet position and the cutting position in a case in which a laminate film Fm meanders to the left side in a conveyance direction FD. In FIG. 5, a target position Pt at which the lamination film Fm is to be arranged is indicated by a colored frame, and an actual arrangement position of the lamination film Fm is indicated by a colorless rectangular frame. In the example illustrated in FIG. 5, the sheet Sh is arranged at a targeted position. Like this, while the position of the sheet Sh is not displaced, the position of the laminate film Fm may be displaced. In such a state, when cutting is executed at an originally planned cutting position, a shift occurs between the outer shape of the product after cutting and the posture of the sheet Sh. The originally planned cutting position is the cutting position in a case in which the laminate film Fm is assumed to be located at the target position Pt.

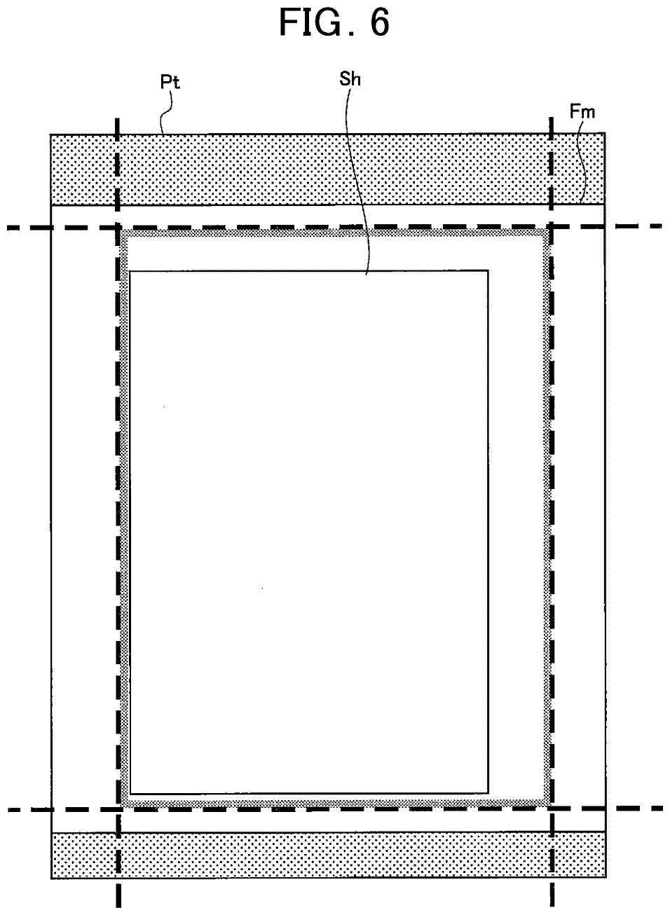

FIG. 6 is a diagram illustrating an example of correspondence between the sheet position and the cutting position in a case in which cutting is performed along the initial cutting position illustrated in FIG. 5. In the example illustrated in FIG. 6, since cutting is performed on the assumption that the laminate film Fm is located at the target position Pt, there is almost no gap between the cutting position and the edge side of the sheet Sh on the left side of the drawing.

The cutting apparatus according to the present embodiment determines the cutting position by the cutting apparatus 4 with reference to the position of the outer shape of the sheet Sh to be laminated with the laminate film Fm, rather than the outer shape of the laminate film Fm. According to the cutting apparatus of the present embodiment, it is possible to eliminate the shift of the posture of the sheet Sh in the laminate film Fm with respect to the outer shape of the laminate film Fm after cutting.

### <Configuration of Image Forming System>

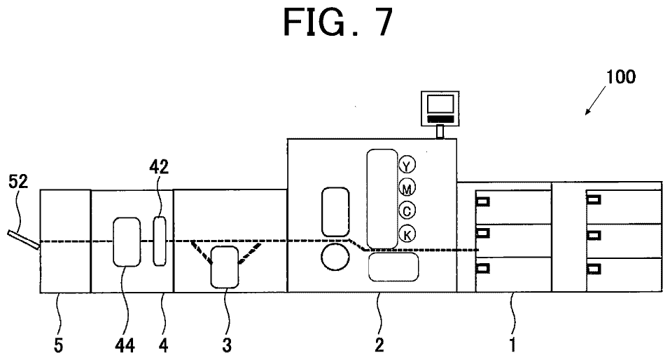

Next, the configuration of an image forming system according to an embodiment of the present invention will be described. FIG. 7 is a schematic diagram illustrating an overall configuration of an image forming system 100. As illustrated in FIG. 7, the image forming system 100 includes a sheet feed device 1, an image forming apparatus 2, a laminating apparatus 3, a cutting apparatus 4, and a sheet ejection device 5.

The sheet feed device 1 feeds the sheet, which is an example of a recording medium, from a sheet feed tray (not illustrated) and conveys the sheet to the image forming apparatus 2 with a conveyor. The sheet feed device 1 may comprise a central processing unit (CPU) or implemented and/or controlled by a central processing unit (CPU) 251 of the image forming apparatus 2 described later.

The image forming apparatus 2 forms (prints) an image on the sheet Sh fed from the sheet feed device 1 according to a print job input from a terminal apparatus or the like (not illustrated).

The laminating apparatus 3 performs laminating on the sheet by superimposing laminating films on both the front and rear faces of the sheet conveyed from the image forming apparatus 2.

The cutting apparatus 4 includes a sheet edge detector 42, a cutting position determiner 43, and a cutting section 44.

The sheet edge detector 42 (an example of a recording medium outer shape detector) includes a sensor section (not illustrated) such as a line sensor. The sheet edge detector 42 acquires a position of an edge of the sheet based on a read image obtained by the sensor section.

The cutting section 44 determines a position of a cutter (not illustrated) for cutting based on information on the position of the sheet detected by the sheet edge detector 42, and cuts the laminate film at a determined position. The cutter is formed of, for example, a rotary cutter.

The sheet ejection device 5 includes a sheet ejection section 52, and ejects the product generated by the cutting apparatus 4 to the sheet ejection section 52.

### <Configuration of Control System of Image Forming System>

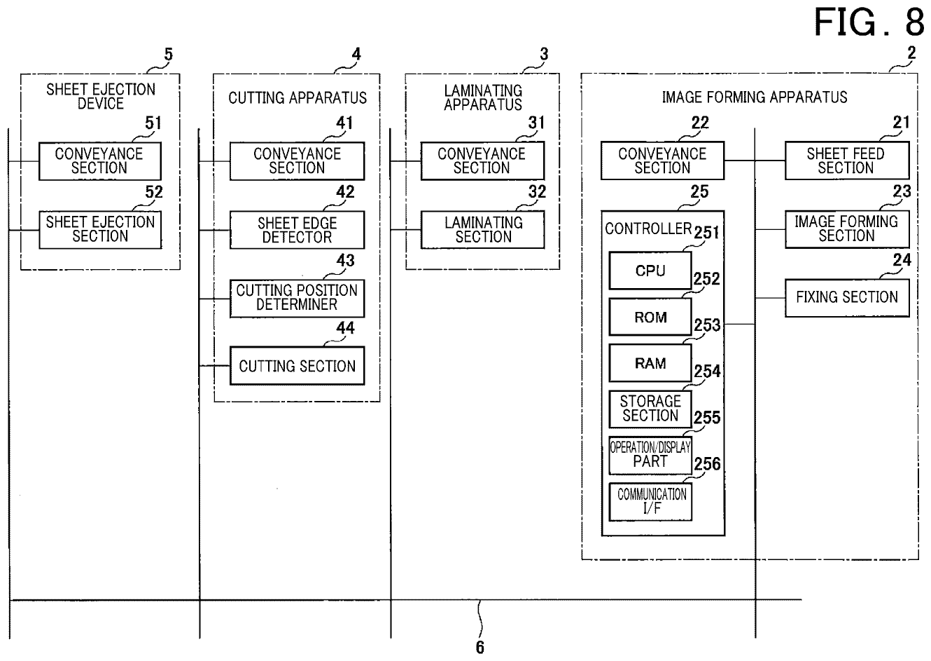

Next, a configuration of a control system of the image forming system 100 according to an embodiment of the present invention will be described. FIG. 8 is a block diagram illustrating a configuration example of a control system of the image forming apparatus 2, the laminating apparatus 3, the cutting apparatus 4, and the sheet ejection device 5 constituting the image forming system 100.

### [Image Forming Apparatus]

As illustrated in FIG. 8, the image forming apparatus 2 includes a sheet feed section (or sheet feeder) 21, a conveyance section (or conveyor) 22, an image forming section (or image forming device) 23, a fixing section (or fixer) 24, and a controller (or hardware processor) 25.

The sheet feed section 21 feeds the sheet stored in a sheet feed tray (not illustrated) to the image forming section 23 via a conveyance path (not illustrated).

The conveyance section 22 performs control to convey the sheet fed by the sheet feeding section 21 via the conveyance path.

The image forming section 23 forms (prints) the image on the sheet, for example, using an image forming method such as an electrophotographic method or an inkjet method.

The fixing section 24 fixes the image onto the sheet by pressing the sheet on which the image is formed with a fixing roller (not illustrated) having a heating section therein.

The controller 25 controls the operations of the above-described sections constituting the image forming apparatus 2. The controller 25 includes the CPU 251, a read only memory (ROM) 252, a random access memory (RAM) 253, a storage section (or storage) 254, an operation/display part (or operation/display device) 255, and a communication interface (I/F) 256.

The CPU 251 reads, from the ROM 252, a program code of software that implements each function according to the present embodiment, develops the program code in the RAM 253, and executes the program code. In the RAM 253, variables, parameters, and the like generated during arithmetic processing by the CPU 251 are temporarily written.

Note that the controller 25 may include a processing device such as a micro-processing unit (MPU) instead of the CPU 251. Furthermore, in the controller 25, the CPU and the MPU may be used in combination. In addition, the controller 25 may be configured by a field-programmable gate array (FPGA), an application specific integrated circuit (ASIC), or the like.

The storage section 254 includes, for example, a hard disk drive (HDD), a solid state drive (SSD), an optical disk, a nonvolatile memory card, or the like. The storage section 254 stores an operating system (OS), various parameters, a software program that implements each function according to the present embodiment, and the like. It should be noted that the program may be stored in the ROM 252.

The program is stored in the form of a computer-readable program code, and the CPU 251 sequentially executes operations according to the program code. That is, the ROM 252 or the storage section 254 is used as an example of a computer-readable non-transitory recording medium that stores a program to be executed by a computer.

The operation/display part 255 includes an operation input part and a display part. The operation input part is configured by, for example, a button, a key, or the like, generates an operation signal corresponding to an operation by the user, and supplies the operation signal to the CPU 251. The display part is, for example, a monitor constituted by a liquid crystal display (LCD) or the like. The operation input part and the display part constituting the operation/display part 255 may be integrally configured as a touch panel device.

For example, a network interface card (NIC) or the like is used for the communication I/F 256. The communication I/F 256 can transmit and receive various types of data to and from a terminal apparatus (not illustrated) via a network or a communication line.

### [Laminating Apparatus]

The laminating apparatus 3 may comprise a central processing unit (CPU), and includes a conveyance section 31 and a laminating section 32, which may be implemented and/or controlled by the CPU of the laminating apparatus 3 or the CPU 251.

The conveyance section 31 comprises a conveyor and performs control to convey the laminate film and the sheet with the conveyor.

The laminating section 32 comprises a laminator and performs a laminating process with the laminator by laminating and pressing a laminate film having an adhesive layer on each of a front surface and a rear surface of a sheet. Furthermore, the laminating section 32 cuts the laminated sheet in a direction orthogonal to (intersecting) the conveyance direction. Thus, the laminated film after the lamination processing is cut off from a lamination roll (not illustrated).

### [Cutting Apparatus]

The cutting apparatus 4 may comprise a central processing unit (CPU), and includes a conveyance section 41, a sheet edge detector 42, a cutting position determiner 43, and a cutting section 44, which may be implemented and/or controlled by the CPU of the cutting apparatus 4 or the CPU 251.

The conveyance section 41 comprises a conveyor and performs control to convey the laminated sheet conveyed from the laminating apparatus 3 with the conveyor.

The sheet edge detector 42 obtains a two dimensional image (read image) of one sheet by integrating the image in the sheet width direction acquired by the sensor section (not shown) in a time direction. Then, the sheet edge detector 42 detects a size of the sheet (hereinafter, also referred to as “actual measured sheet size”) and the positions of the edges (four sides) of the sheet based on the read image of the sheet.

The cutting position determiner 43 determines cutting positions based on the actual measured sheet size detected by the sheet edge detector 42 and information on the positions of the edges (four sides) of the sheet.

The cutting section 44 includes the cutter (not illustrated). The cutter includes the cutter disposed parallel to the conveyance direction of the sheet and the cutter disposed parallel to the width direction of the sheet. The cutting section 44 cuts the laminate film with the cutter at the cutting position determined by the cutting position determiner 43.

### [Sheet Ejection Device]

The sheet ejection device 5 may comprise a central processing unit (CPU), and includes a conveyance section 51 and a sheet ejection section 52, which may be implemented and/or controlled by the CPU of the sheet ejection device 5 or the CPU 251.

The conveyance section 51 comprises a conveyor and performs control to convey the laminated and cut laminate film (product) output from the cutting apparatus 4 to the sheet ejection section 52 with the conveyor.

The sheet ejection section 52 is a tray onto which a product is ejected.

### <Outline of Cutting Position Determining Processing>

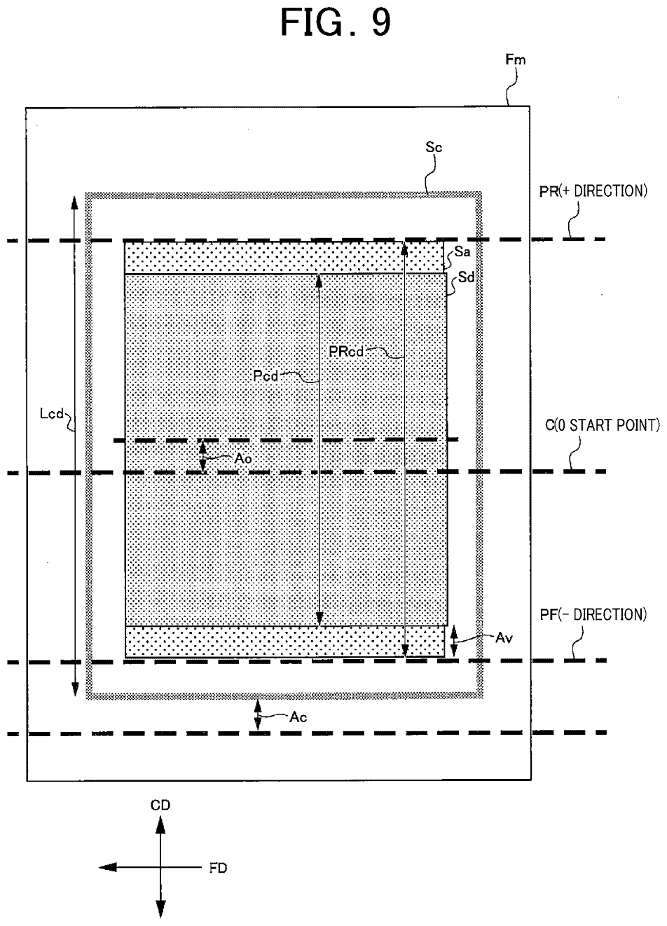

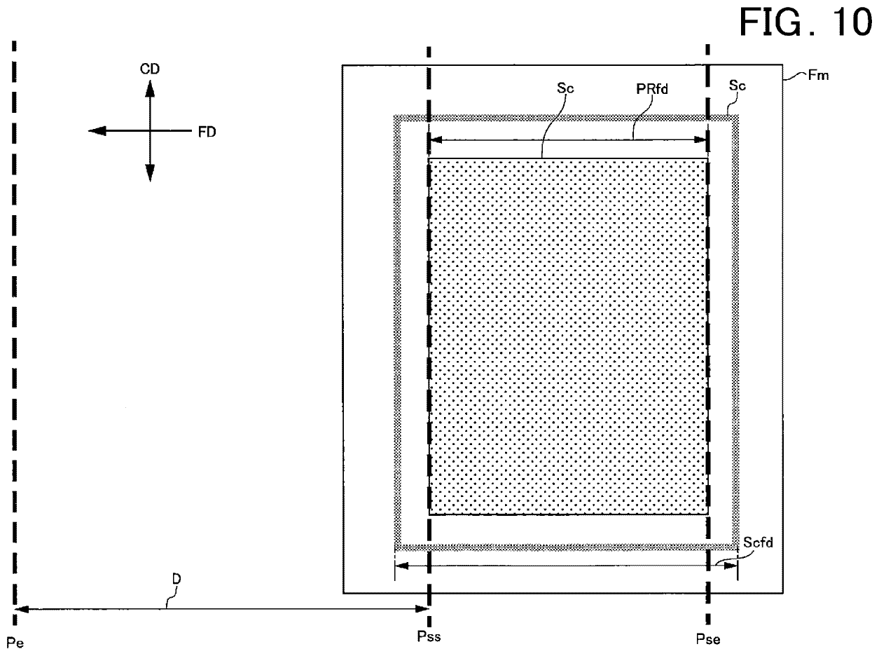

Next, an outline of the cutting position determining processing by the image forming system 100 according to the present embodiment will be described with reference to FIG. 9 and FIG. 10. FIG. 9 is a diagram illustrating an example of cutting position determining parameters in a sheet direction. FIG. 10 is a diagram illustrating an example of the cutting position determining parameters in a sheet conveyance direction.

Each parameter illustrated in FIG. 9 is used when the controller 25 determines the cutting position in the sheet width direction (hereinafter, also referred to as the “CD-direction”) of the cutter (not illustrated) of the cutting apparatus 4.

The outermost rectangular frame in FIG. 9 indicates the laminate film Fm, and the inner rectangular frame indicates a cut-out setting size Sc of the laminate film Fm. Furthermore, in FIG. 9, a specified sheet size Sd is indicated by a fine dot pattern, and an actual measured sheet size Sa is indicated by a coarse dot pattern. FIG. 9 shows an example in which the actual measured sheet size Sa is larger than the specified sheet size Sd.

The cutting position determiner 43 (see FIG. 8) of the cutting apparatus 4 calculates a correction amount of a CD-direction cutting position using the following formula (1). Next, the cutting position determiner 43 determines the cutting position using the calculated correction amount.

CD-direction cutting position correction amount=center offset amount Ao+sheet variation amount Av formula (1)

The center offset amount Ao indicates a shift amount from a conveyance center position C in the CD-direction. The conveyance middle position C is a target position where the center line of the sheet Sh in the CD-direction is to be located. The shift amount of the conveyance center position C to the near side (the lower side in the drawing) with respect to “0” is indicated by a “−” (minus) value. On the other hand, the shift amount of the conveyance center position C with respect to “0” to the back side (upper side in the drawing) is indicated by a “+” (plus) value. The shift amount or each of the coordinates of the edges of the four sides of the sheet Sh is indicated by, for example, a unit of mm or dots. The center offset amount Ao can be calculated using the following formula (2).

center offset amount Ao=(sheet near edge position PF+sheet far edge position PR)/2 formula (2)

The sheet variation amount Av indicates the shift amount between a specified value and an actual measured value of the length of the sheet Sh in the CD-direction. The sheet variation amount Av can be calculated using the following formula (3).

sheet variation amount Av=(CD-direction length specified value Pcd+CD-direction length actual measured value PRcd)/2 formula (3)

For example, it is assumed that the sheet near edge position PF is “100” and the sheet far edge position PR is “−112”. In this case, the center offset amount Ao is calculated as “−6” based on formula (2) described above.

In addition, for example, it is assumed that the CD-direction length specified value Pcd is “210 (mm)” and the CD-direction length actual measured value PRcd is “212 (mm)”. In this case, the sheet variation amount Av can be calculated to be “1” based on the above formula (3).

Next, the cutting position determiner 43 can calculate the CD-direction cutting position correction amount of “−5” by substituting the obtained center offset amount Ao and the sheet variation amount Av into the formula (1) above.

For example, it is assumed that the specified value (target value) of the near edge position of the sheet Sh is “−105” and the set value of the margin amount from the edge side of the sheet of the specified size to the edge side of the laminate film after cutting is “10”. In this case, the specified value (the value before correction) of the cutting position on the near side of the sheet Sh is “−115”. In a case in which the CD-direction cutting position correction amount is “−5”, the cutting position determiner 43 sets the position of “−120” obtained by adding “−5” of the CD-direction cutting position correction amount to “−115” as the cutting position on the near side in the CD-direction.

It is also assumed that the specified value (target value) of the far edge position of the sheet Sh is “105”. In this case, since the margin amount is “10”, the specified value of the cutting position on the far side of the sheet Sh is a position of “115”. In a case in which the CD-direction cutting position correction amount is “−5”, the cutting position determiner 43 sets the position of “110” obtained by adding “−5” of the CD-direction cutting position correction amount to “115” as the cutting position on the far side in the CD-direction.

Next, an outline of processing for determining the cutting position in the sheet conveyance direction (hereinafter, also referred to as the “FD-direction”) will be described with reference to FIG. 10. The adjustment of the cutting position in the FD-direction is performed by moving the laminate film Fm in the FD-direction while fixing the position of the cutter. That is, the correction amount of the cutting position in the FD-direction is the movement amount (an example of the conveyance amount) of the laminate film Fm in the FD-direction.

As for the cutting position in the FD-direction, the cutting position determiner 43 first determines the cutting position on the leading end side in the FD-direction. Next, the cutting position determiner 43 sets, as the cutting position on the trailing end side, the position moved from the cutting position on the leading end side by the cut-out setting size in the FD-direction (hereinafter referred to as the “FD-direction cut-out setting size Scfd”). The FD-direction cut-out setting size Scfd indicates the size in the FD-direction cut by the cutting section 44. The FD-direction cut-out setting size Scfd is set to a size that is larger than the outer shape (four sides) of the sheet of the specified size by the margins.

The cutting position determiner 43 (see FIG. 8) sets the cutting position on the leading end side based on a movement amount (distance) from the position where the acquisition of the read image by the sensor section of the sheet edge detector 42 is completed (hereinafter, referred to as “read image acquisition ending position Ps”). The cutting position determiner 43 can calculate a leading end cutting stop distance, which is a movement distance from the read image acquisition ending position Ps to the cutting position on the leading end side, by using the following formula (4).

Leading end cutting stop distance=Cutting stop movement distance D-(FD-direction cut-out setting size Scfd−actual sheet size PRfd)/2 formula (4)

The “cutting stop movement distance D” in the above formula (4) is a movement distance from the read image acquisition start position Pss to the cutter arrangement position Pe.

The cutting position determiner 43 measures the distance to the cutter arrangement position Pe at the time point when the leading end of the sheet Sh passes through the position of the sensor section of the sheet edge detector 42. Then, at the time when the detection of the trailing end of the sheet by the sensor section of the sheet edge detector 42 is finished, the cutting stop movement distance D is calculated based on the information of the position of the trailing end of the sheet and the information of a conveyance speed of the laminate film Fm.

The conveyance section 41 of the cutting apparatus 4 stops conveying the laminate film Fm at the time point when the laminate film Fm has moved by the leading end cutting stop distance from the state in which the sensor section is located at a read image acquisition end position Pse. Next, the cutting section 44 cuts the laminate film Fm with a cutter (not illustrated). Thus, the cutting section 44 cuts the sheet Sh at a position outward from the edge of the leading end of the sheet Sh by the margin.

According to the present embodiment, the cutting position is determined based on the actual measured sheet size acquired by the sheet edge detector 42. Therefore, even when the actual measured sheet size includes a shift from the specified size, the outer shape of the cut product can be maintained in a constant shape. Furthermore, in the present embodiment, the cutting position is determined by the cutting position determiner 43 based on the read image acquisition end position Pse by the sensor section and the FD-direction cut-out setting size Scfd. Therefore, according to the present embodiment, it is possible to prevent a shift from occurring between the outer shape of the product after cutting and the outer shape of the sheet Sh.

### <Cutting Position Determining Processing>

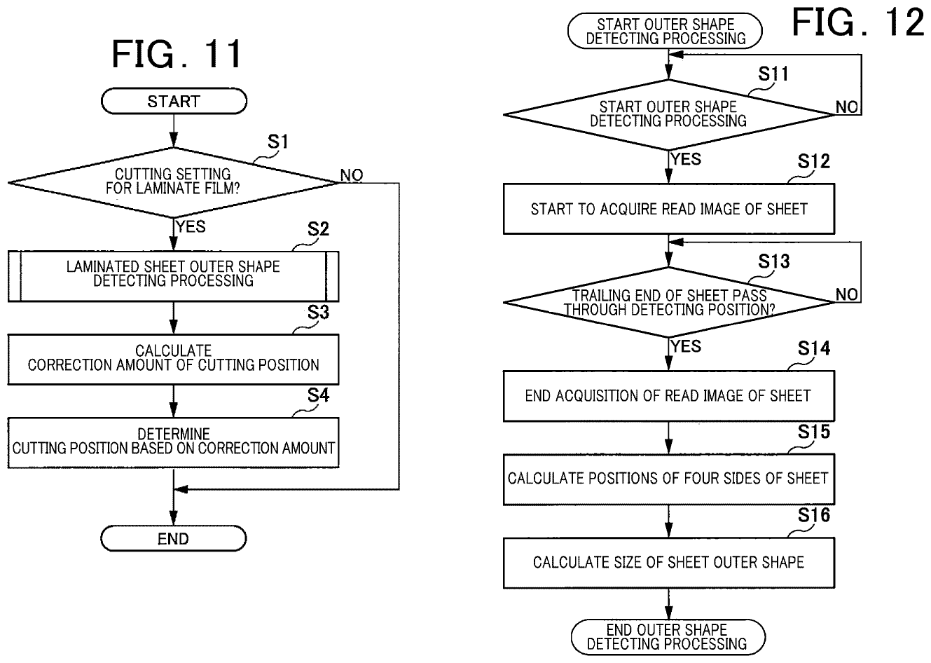

Next, cutting position determining processing performed by the cutting apparatus 4 according to the present embodiment will be described with reference to FIG. 11. FIG. 11 is a flowchart illustrating an example of a procedure of cutting position determining processing.

First, the controller 25 (see FIG. 8) determines whether or not the cutting of the laminate film is set based on a print job transmitted from a terminal apparatus (not shown) (step S1). In a case in which the cutting is not set (NO in S1), the cutting position determining processing by the cutting apparatus 4 is ended.

On the other hand, in a case in which it is determined that the cutting is set (YES in S1), the sheet edge detector 42 of the cutting apparatus 4 performs the outer shape detecting processing of the laminated sheet (S3). The outer shape detecting processing in S3 will be described in detail with reference to the next FIG. 12.

Next, the cutting position determiner 43 calculates the correction amount of the cutting position based on the information on the outer shape of the sheet calculated in S3 (S4). Next, the cutting position determiner 43 determines the cutting position by a cutter (not illustrated) using the correction amount calculated in S4 (S5). After the processing of S5, the cutting position determining processing by the cutting apparatus 4 ends.

Next, referring to FIG. 12, the sheet outer shape detecting processing executed in S3 of FIG. 11 will be described. FIG. 12 is a flowchart illustrating an example of a procedure of the sheet outer shape detecting processing. First, the sheet edge detector 42 determines whether the leading end of the sheet in the laminate film has reached a detecting position of a sensor (not illustrated) (S11). In a case in which it is determined in S11 that the leading end of the sheet has not reached the position (NO in S11), the sheet edge detector 42 repeats the determination in S11.

On the other hand, in a case in which it is determined that the sheet has arrived (YES in S11), the sheet edge detector 42 starts to acquire a read image of the sheet (S12). Next, the sheet edge detector 42 determines whether the trailing end of the sheet has passed the detecting position (S13). If it is determined in S13 that the trailing end of the sheet has not passed (NO in S13), the sheet edge detector 42 repeats the determination in S13.

On the other hand, in a case in which it is determined that the trailing end of the sheet has passed (YES in S13), the sheet edge detector 42 ends the acquisition of the read image of the sheet (S14). Next, the sheet edge detector 42 calculates the positions of the four sides of the sheet based on the read image (S15). Next, the sheet edge detector 42 calculates the size of the outer shape of the sheet based on the information on the positions of the four sides of the sheet (S16). After the process of S16, the cutting position determiner 43 ends the outer shape detecting processing.

In the above-described embodiment, the cutting position determiner 43 determines the cutting position by the cutting apparatus 4 with reference to the position of the outer shape portion of the sheet detected by the sheet edge detector 42. That is, in the present embodiment, even in a case in which the laminate film meanders during conveyance or the like, the cutting position is determined with reference to the position of the outer shape portion of the sheet rather than the posture of the laminate film. Therefore, according to the present embodiment, it is possible to eliminate the shift of the posture of the recording medium in the laminate film with respect to the outer shape of the cut laminate film.

Furthermore, in the embodiment described above, the cutting position determiner 43 calculates the position of the center line of the laminated sheet in the CD-direction orthogonal to (intersecting) the FD-direction, based on the information on the outer shape portion of the sheet detected by the sheet edge detector 42. Then, the cutting position determiner 43 corrects the cutting position based on information (center offset amount Ao, see FIG. 9) of the difference between the position of the center line and the target position at which the center line is to be arranged. Therefore, according to the present embodiment, even in a case in which the conveyance position of the sheet is shifted, it is possible to eliminate the shift of the posture of the recording medium in the laminate film with respect to the outer shape of the cut laminate film.

Furthermore, in the above-described embodiment, the cutting position determiner 43 corrects the margin amount based on the information on the difference between the size of the outer shape portion of the sheet in the direction substantially parallel to the FD-direction and the specified size of the sheet in the same direction. Therefore, even when the size of the sheet includes the shift, the outer shape of the laminate film after cutting is maintained in a constant shape.

Note that in the above-described embodiment, the example in which the margin is included between the laminated sheet and the cutting position of the laminate film has been described, but the margin amount may be “0”. That is, the cutting apparatus according to the present embodiment may cut the position of the outer shape of the laminated sheet.

In addition, in the above-described embodiments or modification examples, the configurations of the apparatus and the system have been described in detail and specifically in order to explain the present invention in an easily understandable manner, and the present invention is not necessarily limited to those including all the configurations described above.

In addition, control lines and information lines considered to be necessary for description are illustrated in FIG. 8 by solid lines, and all of the control lines and information lines on a product are not necessarily illustrated. In reality, it may be considered that almost all of the components are coupled to each other.

Further, in the present specification, processing steps describing time-series processing include not only processing performed in a time-series manner according to the described order, but also processing performed in parallel or individually (for example, parallel processing or processing by an object), which is not necessarily performed in a time-series manner.

Although embodiments of the present invention have been described and illustrated in detail, the disclosed embodiments are made for purposes of illustration and example only and not limitation. The scope of the present invention should be interpreted by terms of the appended claims.

What is claimed is:

1. A cutting apparatus comprising:
a cutter that cuts a recording medium, both sides of which are laminated with a laminate film, at a position to an outer side by a predetermined margin amount;
a recording medium outer shape detector that detects an outer shape portion of the recording medium; and
a hardware processor that determines a cutting position by the cutter based on a position of the outer shape portion detected by the recording medium outer shape detector.

2. The cutting apparatus according to claim 1, wherein
the cutter is disposed parallel to a conveyance direction of the recording medium, and
the hardware processor corrects the cutting position by changing a movement amount of the cutter in a direction orthogonal to the conveyance direction.

3. The cutting apparatus according to claim 2, wherein
the hardware processor:
calculates a position of a center line of the recording medium in a direction intersecting the conveyance direction, based on information on the outer shape portion detected by the recording medium outer shape detector, and
corrects the cutting position based on information on a difference between the position of the center line and a target position at which the center line is to be arranged.

4. The cutting apparatus according to claim 3, wherein
the recording medium outer shape detector acquires information on a size of the outer shape portion in the direction intersecting the conveyance direction, and
the hardware processor corrects, based on the information on the size of the outer shape portion, the cutting position that is preset based on a specified size of the recording medium.

5. The cutting apparatus according to claim 4, wherein
the hardware processor corrects the margin amount based on information on a difference between a size of the outer shape portion in a direction substantially parallel to the conveyance direction and a specified size of the recording medium in the direction substantially parallel to the conveyance direction.

6. The cutting apparatus according to claim 1, wherein
the cutter is disposed parallel to a direction intersecting a conveyance direction of the recording medium, and
the hardware processor corrects the cutting position by changing a conveyance amount of the recording medium.

7. The cutting apparatus according to claim 6, wherein
the recording medium outer shape detector acquires information on a length of the outer shape portion in a direction substantially parallel to the conveyance direction, and
the hardware processor determines the conveyance amount based on information on a difference between a length of a cut-out range of the laminate film in the direction substantially parallel to the conveyance direction, the length being preset based on a specified size of the recording medium, and the length of the outer shape portion in the direction substantially parallel to the conveyance direction, the length being detected by the recording medium outer shape detector.

8. The cutting apparatus according to claim 7, wherein
the recording medium outer shape detector detects the outer shape portion based on a read image of the recording medium by a sensor, and
the hardware processor calculates a value obtained by dividing, by 2, a value obtained by subtracting the length of the outer shape portion in the direction substantially parallel to the conveyance direction from the length of the cut-out range of the laminate film, and sets, to the conveyance amount, the value obtained by subtracting the resulting value from a distance from a reading end position of the recording medium by the sensor to an arrangement position of the cutter.

9. An image forming system comprising:
an image forming apparatus that forms an image on a recording medium;
a laminating apparatus that laminates, with a laminate film, both sides of the recording medium on which the image is formed; and
the cutting apparatus that comprises:
a cutter that cuts the recording medium at a position to an outer side by a predetermined margin amount;
a recording medium outer shape detector that detects an outer shape portion of the recording medium; and
a hardware processor that determines a cutting position by the cutter based on a position of the outer shape portion detected by the recording medium outer shape detector.

10. A cutting position determining method performed by a cutting apparatus that comprises a cutter, a recording medium outer shape detector, and a hardware processor, the method comprising:
cutting, by the cutter, a recording medium, both sides of which are laminated with a laminate film, at a position to an outer side by a predetermined margin amount;
detecting, by the recording medium outer shape detector, an outer shape portion of the recording medium; and
determining, by the hardware processor, a cutting position by the cutter based on a position of the outer shape portion detected by the recording medium outer shape detector.
